(19) United States
(12) Patent Application Publication
(10) Pub. No.: US 2002/0018287 A1
(43) Pub. Date: Feb. 14, 2002

(54) Fiber-optic amplifier

(75) Inventors: Holger Zellmer, Magdala (DE); Andreas Tuennermann, Jena (DE)

Correspondence Address: Gerald H. Kiel, Esq., REED SMITH LLP, 375 Park Avenue, New York, NY, 10016-2391, US

(73) Assignee: SCHEIDER Laser Technologies AG

(21) Appl. No.: 09/794,582

(22) Filed: Feb. 27, 2001

(30) Foreign Application Priority Data
Feb. 29, 2000 (DE) 100 09 379.5-33

(51) Int. Cl. H01S 3/00

(52) U.S. Cl. 359/341.1

(57) ABSTRACT

A fiber-optic amplifier comprising a laser source which emits signal radiation in a narrow band on one or more wavelengths in a first end of an amplifier fiber, and amplified signal radiation can be coupled out at a second end of the amplifier fiber. The amplifier fiber is a double-core fiber with a pump core and a laser core and the latter is end pumped or side pumped. The amplifier fiber is a multimode double-core fiber at which or within which is arranged, in the area of its first end, an element for transverse mode selection which suppresses modes higher than the fundamental mode.

### BACKGROUND OF THE INVENTION

a) Field of the Invention

The invention is directed to a fiber-optic amplifier. In particular, the invention is directed to a fiber-optic amplifier having a laser source which emits signal radiation in a narrow band on one or more wavelengths in a first end of an amplifier and amplified signal radiation can be coupled out at a second end of the amplifier fiber.

b) Description of the Related Art

Fiber-optic amplifiers (fiber amplifiers) have belonged to prior art in telecommunications for a long time. They are generally used to amplify pulsed signals (see, e.g., Mikhail N. Zervas (Editor): Optical Amplifiers and their Applications, Trends in Optics and Photonics TOPS Vol. 16, ISBN No. 1-55752-505-6). Double-core fibers, as are described, for example, in DE 195 35 526, have also been known for some time. At present, conventional amplifier stages with crystals as amplifier elements are used to generate powerful pulses (see, e.g., Kazuyoku Tei et al., “Diode-pumped 250-W Zigzag Slab Nd:YAG Oscillator-Amplifier System”, Opt. Lett. 23, 7, pp. 514-516, Apr. 1, 1998). The advantage of a fiber-optic solution consists in a comparatively simplified construction. The problem in fiber-optic reamplification of narrow-band and pulsed lasers consists in the nonlinear optic effects in the fibers. As a rule, these effects depend on the power density (power per unit area) and the fiber length (Agrarval: Nonlinear Fiber Optics, Academic Press, ISBN 0-12-045140-9). Accordingly, it is necessary to keep the fibers as short as possible and to use fibers with large cross-sectional surfaces. Fibers with large cross-sectional surfaces are generally multimode, i.e., the amplification in such fibers generally leads to a deterioration in beam quality. With fiber lasers, this problem was solved through the use of large mode area fibers, as they are called (see J. A. Alvarez-Chavez et al., “High-Energy, high-power ytterbium-doped Q-switched fiber laser”, Opt. Lett. 25, 1, pp 37-39) or adiabatic tapers (tapering of some places on the fibers) (see Irl N. Duling et al., Presentation on Photonics West January 2000).

However, a simultaneous reflection of the pump light at the fiber end, which allows the fiber to be shortened, has not been possible so far through the use of tapers.

### OBJECT AND SUMMARY OF THE INVENTION

It is the primary object of the invention to provide a simply constructed fiber-optic amplifier which generates a high-power laser beam with low beam divergence.

This object of the invention is met in a fiber-optic amplifier comprising a laser source which emits signal radiation in a narrow band on one or more wavelengths in a first end of an amplifier fiber, and amplified signal radiation can be coupled out at a second end of the amplifier fiber. The amplifier fiber is a double-core fiber with a pump core and a laser core and the latter is end pumped or side pumped. The amplifier fiber is a multimode double-core fiber at which or within which is arranged, in the area of its first end, an element for transverse mode selection which suppresses modes higher than the fundamental mode.

The invention makes it possible to use a larger core diameter of the amplifier fiber, wherein the beam quality is not worsened because higher transverse modes are not carried out in the amplifier fiber.

An adiabatic taper is a narrowing of the fiber along a short distance of a few millimeters to centimeters. The length of the taper is typically in the range of 1 mm to 5 cm. The length along which the fiber tapers must be dimensioned such that enough total reflections take place to maintain the beam parameter product of the laser beam guided in the fiber. Due to the many reflections at the conical outer surfaces of the fiber, the mode field diameter in the fiber decreases, while the numerical aperture increases at the same time. Finally, the numerical aperture of the fiber is exceeded initially for higher transverse modes and the higher modes are emitted. Only, or predominantly, the transverse fundamental mode is transmitted through the taper.

The invention will be described more fully with reference to the drawings.

### BRIEF DESCRIPTION OF THE DRAWINGS

In the drawings:

FIG. 1 shows a fiber-optic amplifier according to the prior art;

FIG. 2 shows a fiber-optic amplifier with element for transverse mode selection;

FIG. 3 shows a fiber-optic amplifier with element for transverse mode selection and reflector for pump radiation;

FIG. 4 shows an element for transverse mode selection constructed as a tapered portion of an amplifier fiber;

FIG. 5 shows an element for transverse mode selection constructed as a tapered portion of an amplifier fiber with a reflector for the pump radiation;

FIG. 6 shows an element for transverse mode selection constructed as a mode scrambler; and

FIG. 7 shows an element for transverse mode selection constructed as a mode scrambler with a reflector for the pump radiation.

### DESCRIPTION OF THE PREFERRED EMBODIMENTS

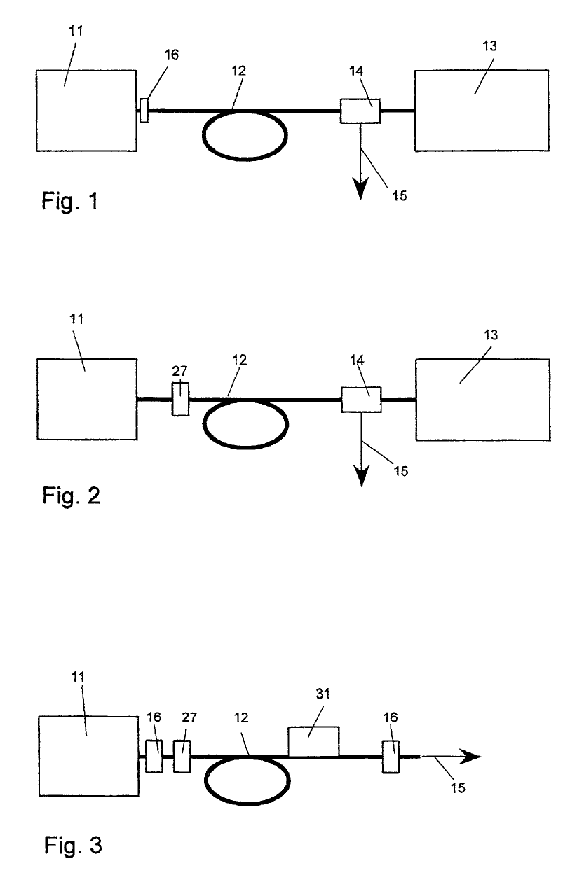

FIG. 1 shows a fiber-optic amplifier according to the prior art. It comprises a laser radiation source 11 whose signal beam is reamplified in an active amplifier fiber 12. Depending on application, the signal beam 11 has special characteristics which must be retained when it is amplified. An example is an especially narrow-band emission at a determined wavelength or at a plurality of determined wavelengths. Another example is that the laser radiation source 11 is operated continuously or in pulsed manner. Accordingly, pulse durations in the range of 100 fs to 1 s, especially between 1 ps and 50 ps, have particular technical relevance. The laser radiation source 11 can be constructed conventionally, for example, as a solid state laser, or fiber-optically.

The amplifier fiber 12 in the example is a rare-earth-doped double-core fiber with a pump core enclosing the active laser core. It is optically coupled at a first end with the laser radiation source 11. In the example, the pump radiation of the amplifier fiber 12 required for amplification is supplied from a pump source 13 through an end face at a second fiber end (end-pumped amplifier). Alternatively, supplying the pump radiation transversely through the outer surface of the fiber is possible (not shown). In the end-pumped system shown here, an output-coupling device for amplified signal beam 14 is integrated in the amplifier fiber 12 at its second end. In the simplest case, this can be a dichroic mirror which separates pumped light from laser light. Wavelength division multiplexers (WDM), as they are called, can also be used.

Further, a reflector 16 is advantageously installed in the amplifier fiber 12 in the area of its first end for the pump radiation. This reflector 16 provides for the reflection of the pump radiation with oppositely directed pump radiation and signal beam. This pump radiation can also be completely absorbed by the reflection of the pump radiation in a shorter amplifier fiber.

FIG. 2 shows an end-pumped fiber-optic amplifier which, according to the invention, is outfitted with an element for transverse mode selection 27 in the area of the first end of the amplifier fiber, where the signal beam to be amplified is coupled in. The object of this element is to eliminate higher transverse modes and to transmit only the transverse fundamental mode.

Accordingly, in a fiber amplifier according to the invention, in order to reduce the power density in the amplifier fiber, the active core of the fiber is enlarged so that nonlinear effects such as, e.g., Stimulated Brillouin Scattering (SBS), Stimulated Raman Scattering (SS) and self-phase modulation (SPM) are prevented or reduced. This usually results in a considerable deterioration in beam quality.

As a result of the element for transverse mode selection 27, higher modes of the internal laser beam are eliminated and essentially only the fundamental mode is amplified. Accordingly, an excellent beam quality of the amplified laser beam is achieved.

It is advisable in the invention to allow the pump radiation and the signal beam which is to be amplified to propagate in opposite directions through the amplifier fiber 12, since the highest pump power density is then present on the out-coupling side of the signal at the second end of the amplifier fiber 12, that is, where the signal beam has been amplified to high intensities. The element for mode selection should lie as close as possible to the side on which the signal is coupled in, that is, opposite the pump side at the first end of the amplifier fiber. Therefore, end-pumped systems are especially advantageous. An out-coupling device 14 is provided at the second end of the amplifier fiber for coupling out the signal beam 15 and for coupling the pump light from the pump source 13 into the amplifier fiber 12.

FIG. 3 shows the fiber-optic amplifier 2 with the element for transverse mode selection and the additional reflector 16 for the pump radiation in a transverse-pumped system. An out-coupling device for amplified signal beam 14 is not required in this case. The pump light source 13 is, e.g., a diode laser which is coupled into the active fiber by means of prisms, diffraction gratings or fused couplers (see, e.g., Weber at al., “A longitudinal and side pumped signal transverse mode double-clad fiber laser with a special silicone coating”, Opt. Commun. 155, pp 99-104, or WO 95/10868.

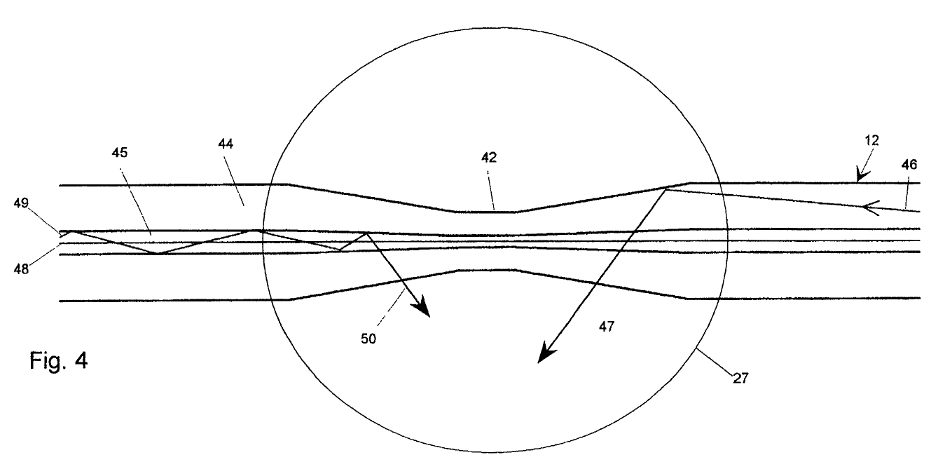

FIG. 4 shows the element for transverse mode selection 27 constructed as tapered portion of an amplifier fiber 12. In the example, a tapered portion of this kind is an adiabatic taper 42 in a double-core fiber 41 comprising a laser core 45 and a pump core 44 enclosing the latter. The adiabatic taper 42 is an adiabatic taper along a length of 3 cm. The length on which the fiber is tapered is long enough so that enough total reflections can occur to maintain the beam parameter product. Due to the many reflections at the conical outer surfaces of the fiber, the mode field diameter in the amplifier fiber 12 decreases, while the numerical aperture increases at the same time. Finally, the numerical aperture of the laser core is exceeded initially for higher transverse modes 49 and the higher modes 50 are emitted. The transverse fundamental mode 48 is transmitted through the adiabatic taper 42.

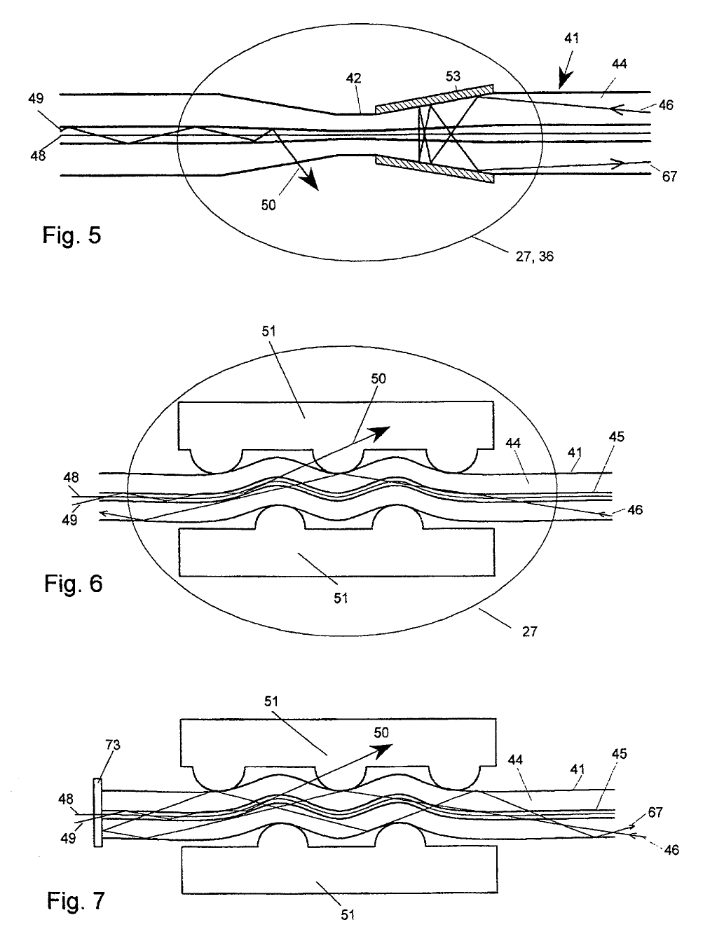

FIG. 5 shows a further development of the fiber-optic amplifier according to FIG. 4. By reflection-coating a portion of the adiabatic taper 42 with a metallic or dielectric mirror layer 53, the pump light 46 is simultaneously reflected in the pump core 44 of the double-core fiber 41. In this connection, the reflecting coating is arranged on the side of the taper located farther away from the laser source 11.

Reflected pumped light 67 is then reflected back into the amplifier fiber and acts along its length. The required length of the amplifier fiber can be reduced considerably in this way, by half in the example. The adiabatic taper serves at the same time as a device for mode selection 27 and as a pump light reflector 16.

FIG. 6 shows the element for transverse mode selection 27 constructed as a mode scrambler.

FIG. 7 shows the element for transverse mode selection 27 constructed as a mode scrambler with a reflector 73 for the pump radiation 46.

While the foregoing description and drawings represent the present invention, it will be obvious to those skilled in the art that various changes may be made therein without departing from the true spirit and scope of the present.

What is claimed is:

1. A fiber-optic amplifier comprising:
an amplifier fiber;
a laser source which emits signal radiation in a narrow band on one or more wavelengths in a first end of said amplifier fiber and amplified signal radiation can be coupled out at a second end of the amplifier fiber;
said amplifier fiber being a double-core fiber with a pump core and a laser core and wherein the laser core is end pumped or side pumped; and
said amplifier fiber being a multimode double-core fiber at which or within which is arranged, in the area of its first end, an element for transverse mode selection which suppresses modes higher than the fundamental mode.

2. The fiber-optic amplifier according to claim 1, wherein the element for transverse mode selection is a spatially limited tapering of the diameter of the laser core or the laser core and pump core.

3. The fiber-optic amplifier according to claim 2, wherein the taper is effected within a range of 1 mm to 5 cm, of the longitudinal extent of the amplifier fiber, wherein the diameter of the pump core and laser core is reduced by at least 50% of its nominal diameter.

4. The fiber-optic amplifier according to claim 2, wherein the taper is effected within a range of 1 mm to 3 cm, of the longitudinal extent of the amplifier fiber, wherein the diameter of the pump core and laser core is reduced by at least 50% of its nominal diameter.

5. The fiber-optic amplifier according to claim 2, wherein the taper is effected within a range of 1 mm to 5 cm, of the longitudinal extent of the amplifier fiber, wherein the diameter of the pump core and laser core is reduced to a diameter of less than 10 μm.

6. The fiber-optic amplifier according to claim 2, wherein the taper is effected within a range of 1 cm to 3 cm, of the longitudinal extent of the amplifier fiber, wherein the diameter of the pump core and laser core is reduced by a diameter of less than 10 μm.

7. The fiber-optic amplifier according to claim 1, wherein the element for transverse mode selection is a mode scrambler.

8. The fiber-optic amplifier according to claim 1, wherein the laser core has a diameter greater than 6 μm μm.

9. The fiber-optic amplifier according to claim 1, wherein an element for pump light reflection is arranged at the first end of the amplifier fiber.

10. The fiber-optic amplifier according to claim 2, wherein an element for pump light reflection is arranged at the first end of the amplifier fiber, wherein the element for pump light reflection is a reflecting coating on the sheathing of the pump core, and wherein the reflecting coating is applied to the side of the taper which lies closer to the second end of the amplifier fiber, so that the pump light is reflected in the direction of the second end of the amplifier fiber and the reflecting coating completely surrounds this area of the taper.

11. The fiber-optic amplifier according to claim 4, wherein an element for pump light reflection is arranged at the first end of the amplifier fiber, wherein the element is a reflecting coating which is arranged on the cross-sectional surface of the first end of the amplifier fiber.

12. The fiber-optic amplifier according to claim 1, wherein the laser source emits continuous or pulsed signal radiation.
